(19) United States
(12) Patent Application Publication
(10) Pub. No.: US 2003/0220820 A1
(43) Pub. Date: Nov. 27, 2003

(54) System and method for the analysis and visualization of genome informatics

(76) Inventors: Christopher P. Sears, Watertown, MA (US); Viviane A. Siino, Watertown, MA (US); Hong Yang, Arlington, MA (US); Bruce D. Pascal, Somerville, MA (US)

Correspondence Address: HALE AND DORR LLP, 300 PARK AVENUE, NEW YORK, NY, 10022, US

(21) Appl. No.: 10/288,607

(22) Filed: Nov. 5, 2002

Related U.S. Application Data
(60) Provisional application No. 60/339,024, filed on Nov. 13, 2001.

(51) Int. Cl. G06F 17/60

(52) U.S. Cl. 705/3

(57) ABSTRACT

A system and method for the visualization and analysis of genome informatics that provides a visualization tool for bioinformatics. Genomic data for many organisms from disparate sources are integrated into a relational database, which continually may be expanded and updated from public sources. Users can visually organize this information, and navigate to points of interest through a graphical interface. Once an object of interest has been located, the relevant data may be extracted in a convenient form specified by the user. The original data remain accessible and can be manipulated or reorganized. Users can import their own data, fully integrate them into the graphical display and add personal annotations to data stored in the database. Biological data integration, data visualization, data annotation, and data storage/management modules provide a unifying interface for bioinformatic data from divergent sources. Specialized components combine genomic data from diverse organisms into one universal format, graph objects in a manageable manner, store data concerning a fragment of genomic data, store relevant data in a relational database, provide user and administrator access and allow users to add custom modules for conducting proprietary analyses through the interface.

### CROSS REFERENCE TO RELATED APPLICATION

Priority is herewith claimed under 35 U.S.C. §119(e) from Provisional Patent Application No. 60/339,024 filed Nov. 13, 2001, which is incorporated by reference in its entirety.

### FIELD OF THE INVENTION

The present invention relates generally to bioinformatics and, in particularly, relates to a system, method and medium for the visualization and analysis of biological data.

### BACKGROUND OF THE INVENTION

DNA provides the building blocks for many of the central biological functions in humans and other organisms. Genes, base pair sequences within DNA, code for the proteins that form the structural components of all biological cells and tissues as well as specialized enzymes for all chemical reactions. Genomics is the study of all of the genes in an organism—their sequences, structure, regulation, interaction, and function. Genomic research involves analyzing the DNA in various tissues to identify novel genes and discover their function within the body. This is accomplished, for example, by comparing the genes expressed in normal and diseased tissue, marking the similarities and differences between them, and, from there, building hypotheses of their function. As genes are typically composed of tens of thousands of DNA base pairs, and there are between 30,000-150,000 genes in the body, genomic research generates massive amounts of data. Bioinformatics, the application of computers to the analysis of biological information, has made it possible to compare seemingly disparate data, decipher patterns and draw inferences about functions.

It can be appreciated that genome informatics analyses have been in use for years. Currently, genome informatics analyses tools include such public domain products as NCBI's Entrez Genome, USCS's GoldenPath, Ensembl, Drosophila, E-Coli, and ACEDB, and commercial products such as Genomax (by Informax), Celera's Discovery System browser, and Lion's SRS platform.

The main deficiencies with conventional genome informatics analysis include:

Narrow scientific application and restricted access to data. Existing products typically provide access to either public databases or a limited number of databases sold by a browser manufacturer. These products are further restrictive in that they do not offer users the ability to integrate their own biological data for the purpose of browsing and analyzing. All online public domain browsers interface with databases that are inaccessible to the user. In some cases, data may be shared (NCBI) or uploaded (Golden Path) which sacrifices the security of a user's data. Celera's Discovery System browses only databases provided by Celera themselves, and certain very limited public domain databases. These databases cannot be appropriately altered or amended to accommodate specific research and analyses.

Limited to analyzing only one genome at a time. Comparisons between the genomes of different organisms are cumbersome when at all possible with existing systems. A goal of genetic science is to determine the genetic proximity of organisms. To do this, individual genetic sequences are compared against known sequences of a genome, or a genome can be compared against another. The results of such an analysis, a Genome Comparison Graph (GCG), is a diagram of all the chromosomes of the genomes with the areas of high similarity indicated. Drosophila and E. coli data systems are limited to those organisms. USCS's GoldenPath and Ensembl deal only with the human genome. AceDB has no such analytic capacity. NCBI's online browser contains some data from human, mouse, rat, zebra fish, drosophila, malaria parasite, and various retroviruses, but provides no way to compare them. Lion's SRS and Celera's Discovery System, similar to NCBI, access multiple other genomes, but do not have the capacity to perform genome similarity comparisons.

Inconvenient and inflexible browser design. Current visualization tools restrict users to specific inquiries, rather than being able to narrow a search by graphical navigation from the genome level down to the elementary sequence level. To obtain relevant information on a particular gene in existing systems, for example, the gene's GenBank accession identification or actual sequence must first be entered into the browser. Current genome visualizers are designed with a particular purpose at the outset, and remain much the same throughout their market presence. In a rapidly evolving field like genomics, it is preferable that any research tool be fully adjustable to follow the changing needs of each client.

### SUMMARY OF THE INVENTION

In view of the foregoing disadvantages inherent in the known types of genome informatics analysis now present in the prior art, the present invention provides a system, method, and medium for the visualization and analysis of genome informatics. Users can visually organize biological data and navigate to points of interest through a graphical interface. Once an object of interest has been located, data associated with the object can be extracted in a convenient form specified by the user. Moreover, the data for which the object is a representation is also accessible and can be readily manipulated and/or reorganized. Users can easily import their own data, fully integrate their data into the graphical display and add personal annotations.

Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

The present invention can be used to provide a graphical interface for the visualization and analysis of genome informatics; a comprehensive display of genomic data from disparate sources; display comparative genomic information from two or more organisms simultaneously; allow a user to fully integrate their own biological data; allow a user multidirectional entry to access the desired data; allow a user to interact and manipulate the data through the display; provide full and flexible access to public and private biological data in a fully integrated, yet secure form; and provide a graphical interface for an efficient computational architecture that allows high system performance in the face of exponential data growth.

Other uses and advantages of the present invention will become obvious to the reader and it is intended that these uses and advantages are within the scope of the present invention.

To the accomplishment of the above and related uses, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other uses, features and attendant advantages of the present invention will become fully appreciated as the same becomes better understood when considered in conjunction with the accompanying drawings, in which like reference characters designate the same or similar parts throughout the several views, and wherein:

FIG. 1 illustrates a flow chart of user operations in accordance with an embodiment of the invention.

FIG. 2 is an illustration of a schematic ideogram cartoon of the human genome that can be used in accordance with an embodiment of the invention.

FIG. 3 is an illustration of a gene density property overlapping Giemsa stain as may appear in a graphical interface in accordance with an embodiment of the invention.

FIG. 4 is an illustration of a number of genes identified for a selected region as may appear in a graphical interface in accordance with an embodiment of the invention.

FIG. 5 illustrates user operations to select a region in accordance with an embodiment of the invention.

FIG. 6 is an illustration of a “track” level view of a portion of one chromosome as may appear in a graphical interface in accordance with an embodiment of the invention.

FIG. 7 is an illustration of a “mouse-over” event associated with a graphic object in accordance with an embodiment of the invention.

FIG. 8 is an illustration of a method of obtaining sequence data in accordance with an embodiment of the invention.

FIG. 9 is an illustration of a sequence view of a portion of one chromosome with select features highlighted as may appear in a graphical interface in accordance with an embodiment of the invention.

FIG. 10 is an illustration of a detailed report of a single object within the genome as may appear in a graphical interface in accordance with an embodiment of the invention.

FIG. 11 is an illustration of a compilation report of one genomic object as may appear in a graphical interface in accordance with an embodiment of the invention.

FIG. 12 is an illustration of a data report of numerous objects within a portion of one chromosome as may appear in a graphical interface in accordance with an embodiment of the invention.

FIG. 13 is an illustration of an uppermost full-genome view of two genomes as may appear in a graphical interface in accordance with an embodiment of the invention.

FIG. 14 illustrates a data processing flow chart in accordance with an embodiment of the invention.

FIG. 15 illustrates an inter-process communications flow chart in accordance with an embodiment of the invention.

### DESCRIPTION OF PREFERRED EMBODIMENTS

The present invention provides a graphical interface for displaying genomics information. The graphical interface provides multiple points of entry to genomic data at any level of data organization and/or data detail. The multi-entry design allows access to neighboring levels of data organization, as well as, navigation from a first level of detail to a second level of detail and vice versa. Users can query for sequences of various kinds and/or types. For example, users can query for sequences from data of specific sequences and view zoomable map information showing neighboring sequences. Users can also locate areas of interest in a genome based on data highlighted on genome-wide ideograms. From the genome-wide ideograms users can navigate into local areas on chromosome maps, and then onto information about biological data such as, for example, individual genes, Express Sequence Tags, (ESTs), and Single Nucleotide Polymorphisms (SNPs), which may be indicated on the maps. Individual gene data, ESTs and SNPs link to related sequences, relevant literature citations, and/or other associated data. Users can also do biological database searches using the interface, which will return links to associated sequences.

The graphical interface integrates biological data into graphical objects. Biological data includes, for example, genome informatics data, sequencing data, gene discovery, gene/biological marker mapping, gene/marker comprehensive reports, restriction enzyme mapping, primer design, full string search, homology search/report, gene/marker expression data, RNA data, protein data, and disease gene mapping/report. For example, each marker/gene and/or sequence interval can be represented by a vector graphic, or other, graphical object, with each object fully responsive. Mouse-over an object brings up information regarding the object, and click-over an object brings up a second view of data and/or a related report about the object.

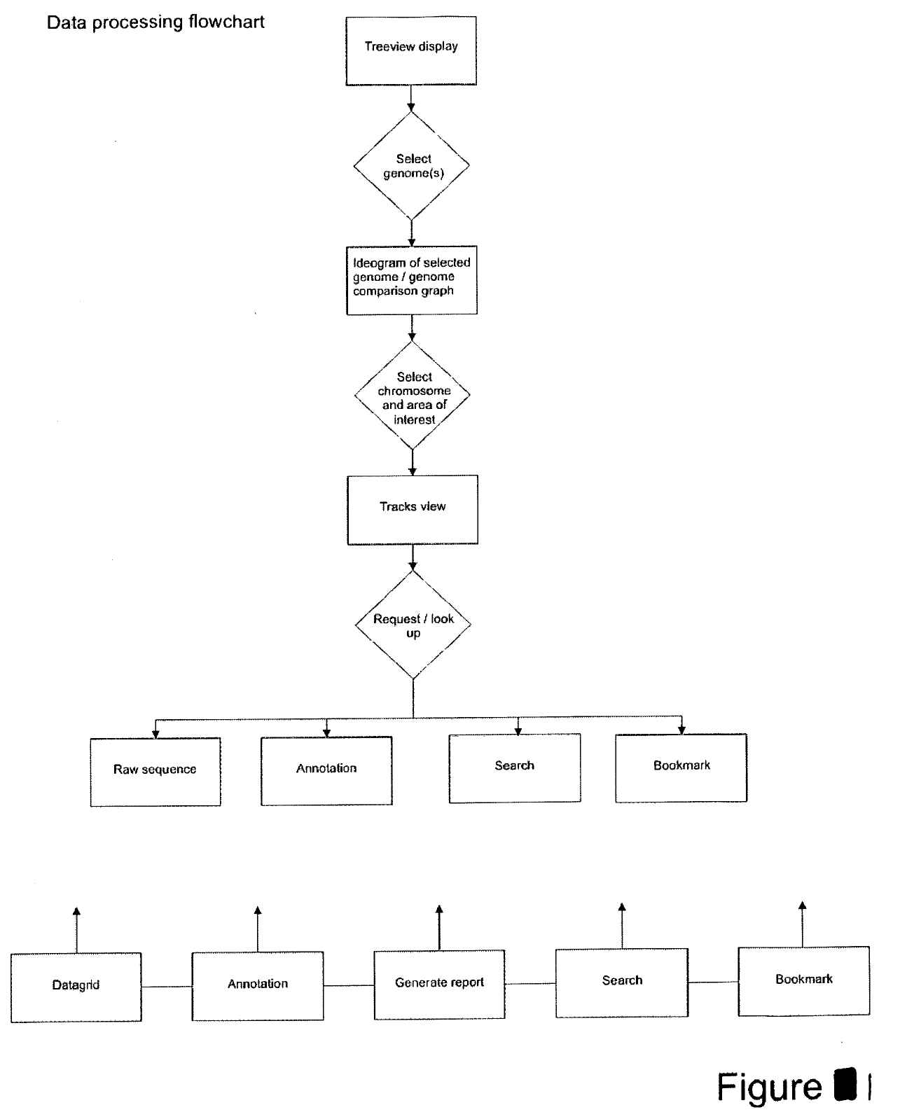

The graphical interface can be used as a multi-entry design genome informatics tool allowing navigation from the general to the specific and vice versa, as well as, lateral data navigation. FIG. 1 illustrates several possible user operations in one embodiment of the present invention. One skilled in the art would appreciate that the journey can take several directions and even reverse direction as indicated by the dashed connections. Operations illustrated in this figure can be performed at any point in the user's navigation. For example, a user may begin the journey using a search tool to either obtain information or view a particular object. Alternatively the user may retrieve the information or view from a bookmark.

As explained more fully below and illustrated in the Figures, the graphical interface can be used to display biological data from one or more databases. The biological data may include genomic data. In response to a query, at least a first type of biological data and a second type of biological data are displayed in the graphical interface. Each type of biological data is displayed as a graphic object at a first scale and is linked to biological data at a second scale. In at least one embodiment, the graphic object is a vector graphic object.

The second type of biological data may be displayed adjacent to or overlaid the first type of biological data. In some embodiments, one or more of the types of biological data are displayed as a track. One or more of the tracks can be ordered relative to other tracks. The display of the types of biological data can take various forms, including a cartoon.

The first, second, and any optional additional types of biological data also may take various forms. For example, each type may include one or more of the following: gene boundaries, chromosome bands seen on Giemsa-stained chromosomes, FISH mapped clones, Sequence Tagged Sites, orthologous (syntenic) regions between mouse and human chromosomes, percentage of bases that are G or C within a predefined base window, contigs of clones, gaps in the assembly, coverage level of the genome, gene predictions from Project Ensembl, CpG islands, Expressed Sequence Tags, UniGene data, Single Nucleotide Polymorphisms, Simple Tandem Repeats, linkage markers, GenScan data, predicted exons, known genes, homologues, and custom annotations. The biological data may include textual information associated with one or more of these types of data, such as a predefined base pair sequence. The types of biological data may represent one or more organisms.

The types of biological data may be obtained experimentally or not. If obtained experimentally, two or more types of biological data may be obtained from the same or from different experimental techniques. For example, one or more types of biological data may be obtained using Geimsa staining.

The first and second scales also may take various forms. For example, the first scale may be a macroscopic biological data set and the second scale may be a subset of the macroscopic data set, or vice versa. More specifically, the first scale may be at a chromosome level of information and the second scale may be at a base pair level of information. In general, the second scale may be at a more detailed or at a higher level. Or, the second scale may be an alternative scale.

The graphical interface may be used to filter predefined biological data from one or more of the types of biological data. This may reveal biological regions associated with, for example, a disease, a gene function, and/or a gene.

The multi-entry design allows multi-level genome informatics navigation. The graphical interface can present different biological genomes in an easily navigable format, and include, for example, tree views of the different genomes, the whole-genome view of a selected organism's chromosomes, a summary report view of the data, detailed track views of a multitude of zoom levels of viewing range, and even a drill-down view of raw sequence details.

A sequence interval can have demarcations showing each exon-intron structure within a particular sequence interval. The start of each gene is labeled by an arrow, which serves as an easy target for mouse-over label. The sequence details can also show splicing junctures, functional/structural domains, signal peptides, transmembrane domains, and statistical analysis on densities of markers within a viewing interval. Raw data is provided for the objects in user-selected intervals, enabling detailed inspection, sorting and filtering operations and easy export of selected data. The graphical interface uses an embedded module to display raw data in the graphical interface in a spreadsheet format and provides spreadsheet-like functionality.

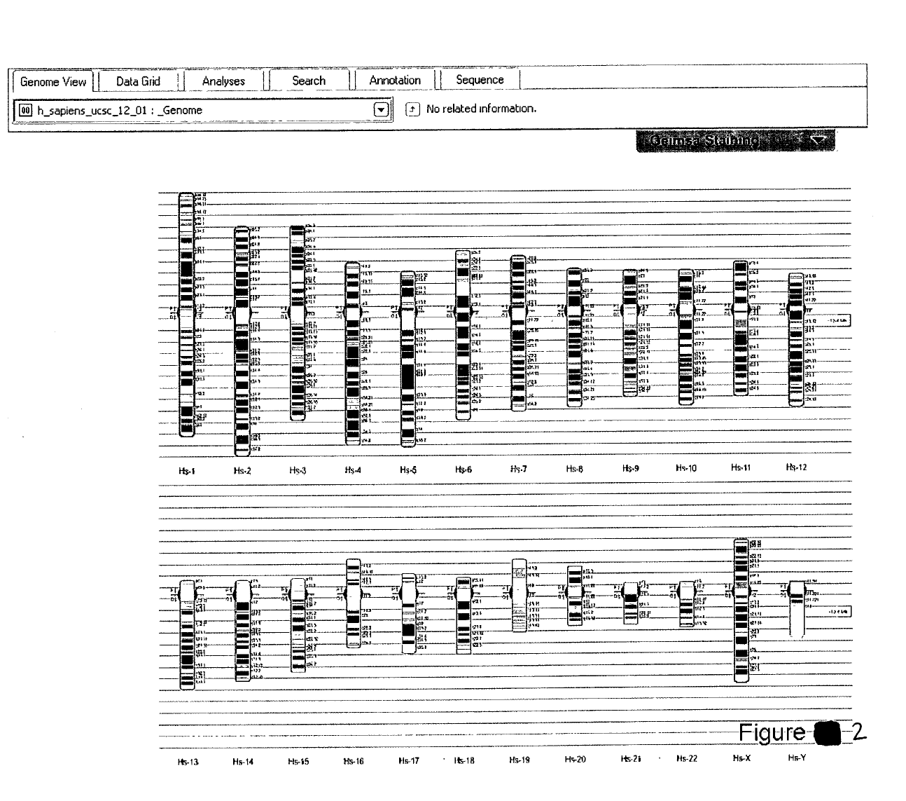

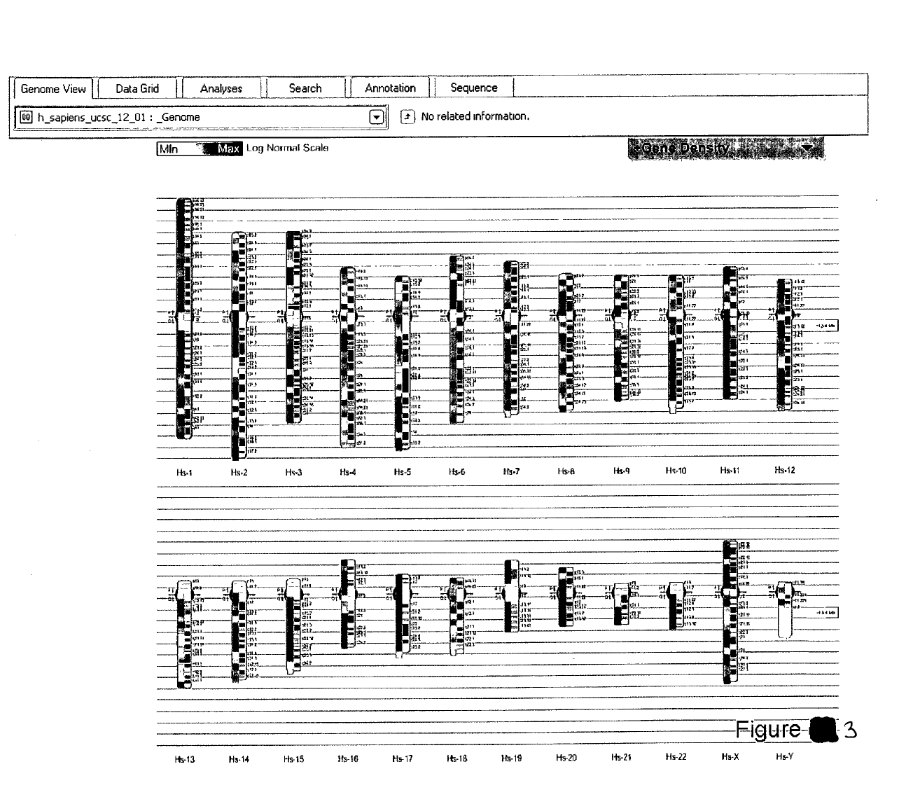

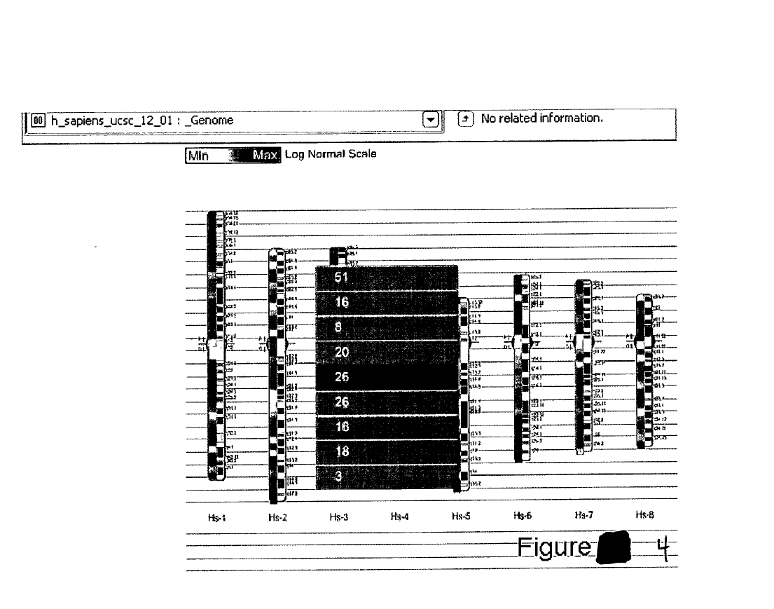

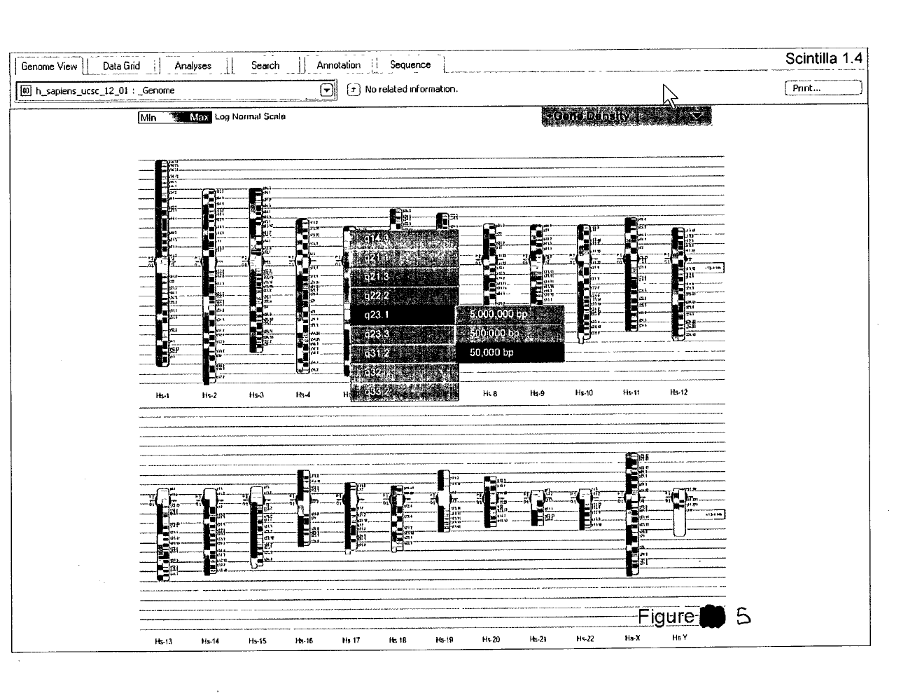

A user can select the desired genome(s) though the use of a tree view, at which point a schematic ideogram cartoon of the genome is displayed. FIG. 2 illustrates a schematic ideogram cartoon of the human genome. The user can then select to overlap, either in part or completely, a new property of the data onto the ideogram. FIG. 3 illustrates the gene density property overlapping Giemsa stain data. Selecting a region on the new property displays informative data to one skilled in the art (e.g. number of genes for the selected region). FIG. 4 illustrates the number of genes identified for a selected region. The user can then navigate to an area of the chromosome. FIG. 5 illustrates a user operation for selecting a genomic region.

The graphical interface can be used to graphically render data from a variety of different genomes in a highly informative and interactive user interface. Data from a number of objects are transparently organized and presented to a user. A user can interact with any of the objects presented in the graphical interface and can explore selected objects from a variety of analysis windows all within the same graphical interface. In addition, whole tracks of objects can be manipulated relative to other tracks of objects. Once a graphical object of interest has been located, data can be easily extracted, either as a convenient summary, or through direct links, such as, through hyperlinks and/or embedded URL's, to further sources of data, including the original source of the data.

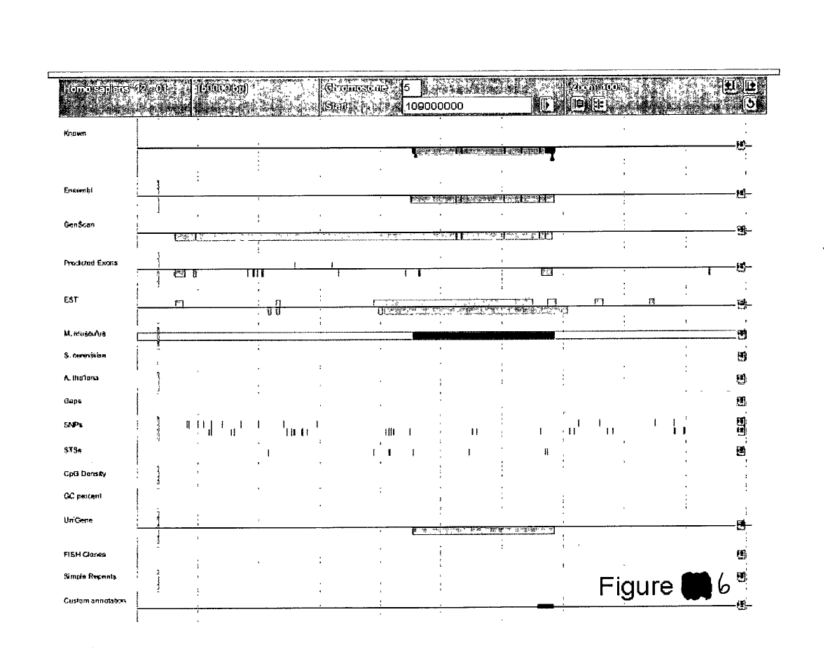

Once a location on a chromosome is selected, the track view is displayed. In this level of detail, data is presented in horizontal tracks. FIG. 6 is an illustration of the “track” level view of a portion of one chromosome. The tracks can display the presence of genes, STSs, SNPs, personal annotations, and other markers. Users can navigate back to a previous level of precision and select a new area of interest. Navigation across the different levels is performed through mouse operations. During navigation, the display of data can be toggled between visual track view and grid format by selecting the tab at the right of the page. Under the track view, the position of current viewing range within the chromosome is indicated in a navigator guide box. Navigation outside of the displayed range is accomplished by dragging the track with the mouse. Scrollbars allow the user to navigate vertically when there are too many tracks to be displayed on the screen.

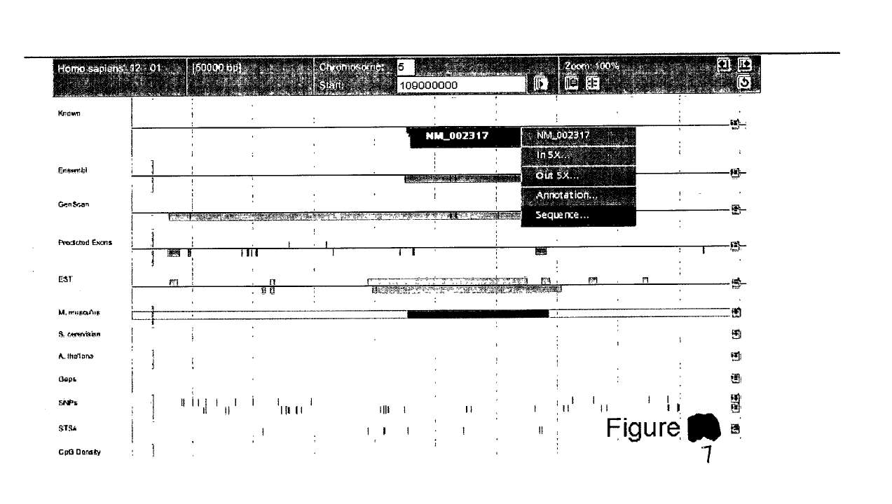

Once a desired element is found, a mouse click will link to further information. A marker can react to a “mouse-over” event showing pertinent summary information (e.g. data source). FIG. 7 is an illustration of a “mouse-over” event. Optionally, line indicators show the start and end positions on the marker (e.g. CDS start positions). This process can be used, for example, to bring the user to lower levels where exons are displayed.

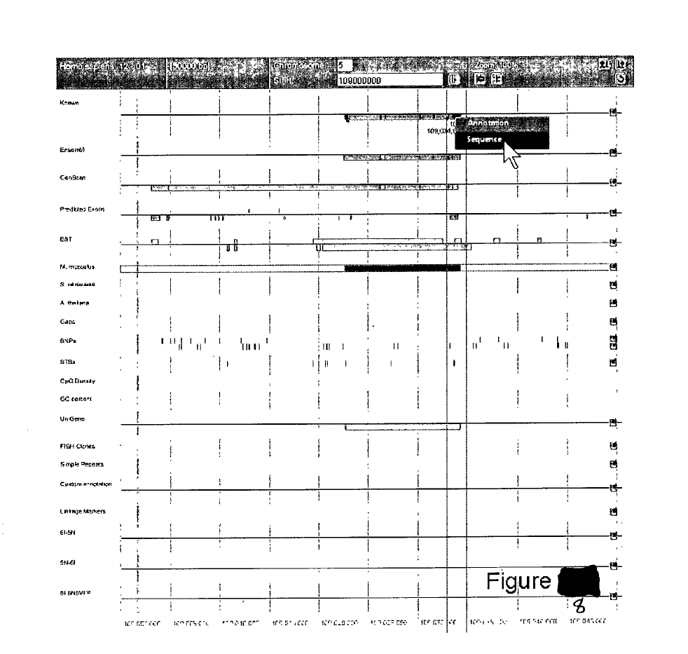

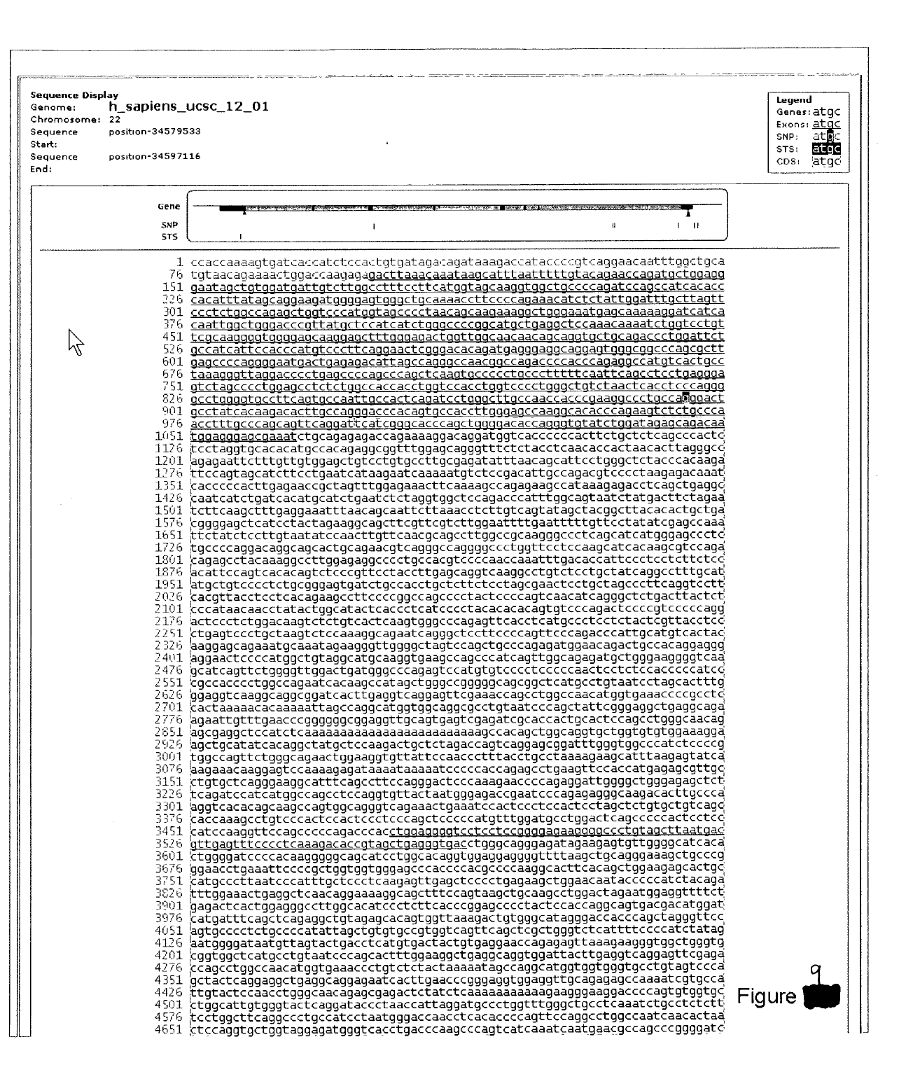

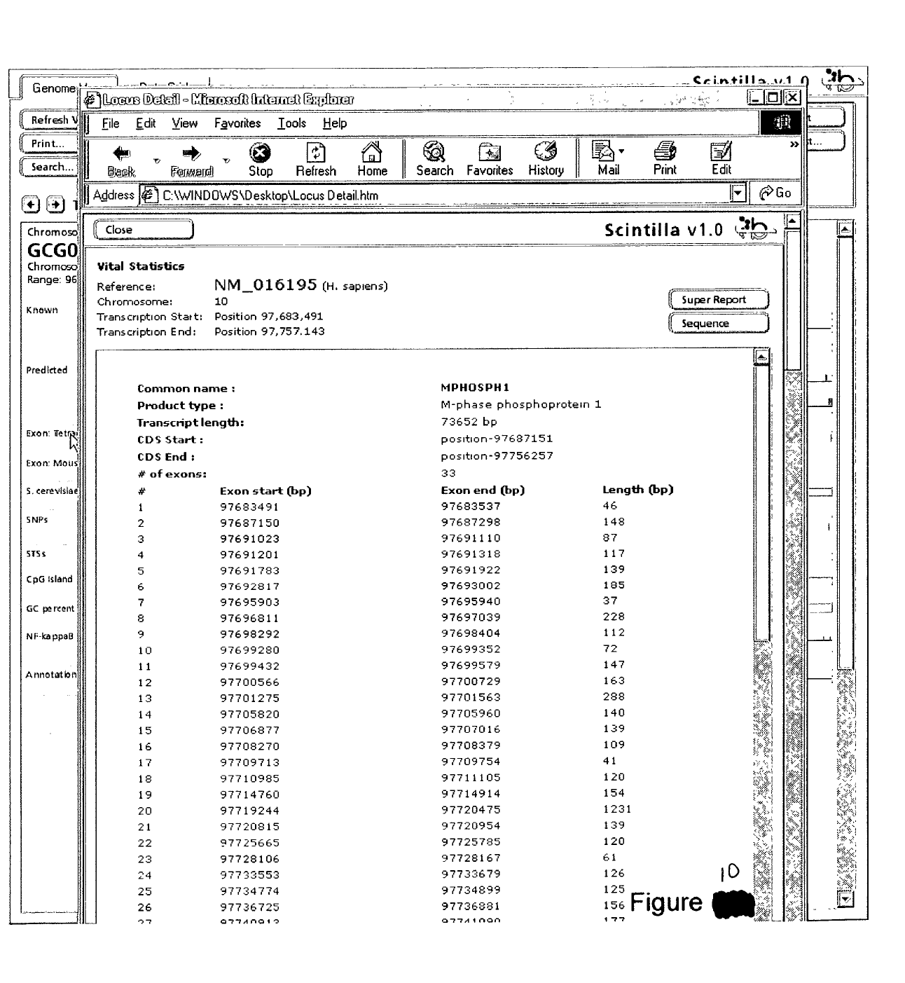

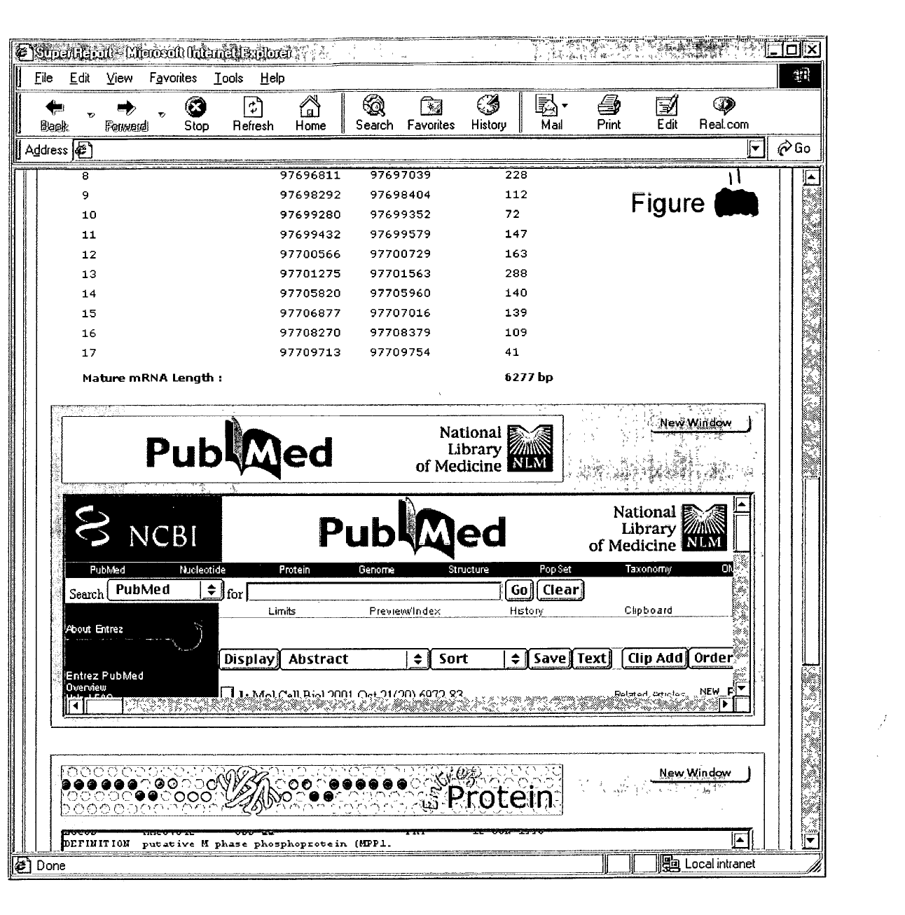

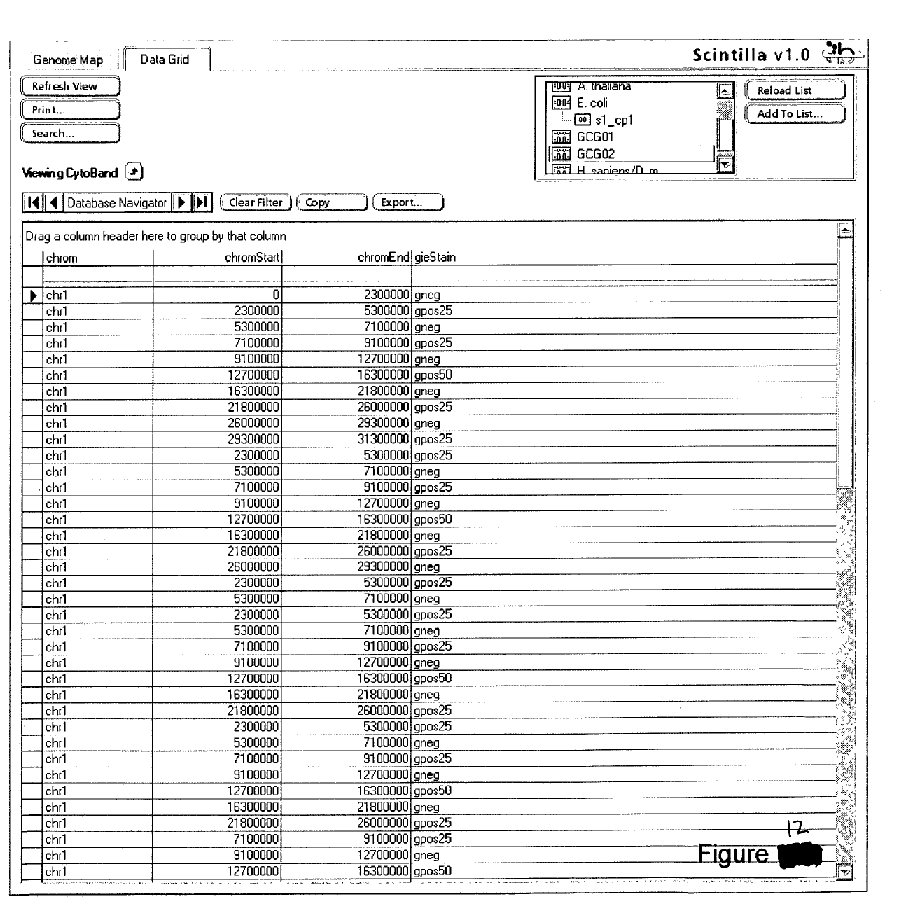

The actual sequence can also be shown in the sequence window. FIG. 8 is an illustration of one method for obtaining sequence data. FIG. 9 is an illustration of the sequence view of a portion of one chromosome with select features highlighted. The graphical interface can be used to generate a variety of reports. FIG. 10 is an illustration of a report of a single object within the genome. FIG. 11 is an illustration of a compilation report of one genomic object. FIG. 12 is an illustration of a data report of numerous objects within a portion of one chromosome. The graphical interface can be used to provide a data report about an object. Report data are integrated from local and remote data sources. In one embodiment, each biological object type is associated with a distinctive report, based on a predetermined set of specifications. Each report forms a pooled data set, which is displayed in the graphical interface. Reports can be triggered by a user through the graphical interface when clicking on a URL linked object. Such a report can be either saved in a user's local system or printed out as a hard copy.

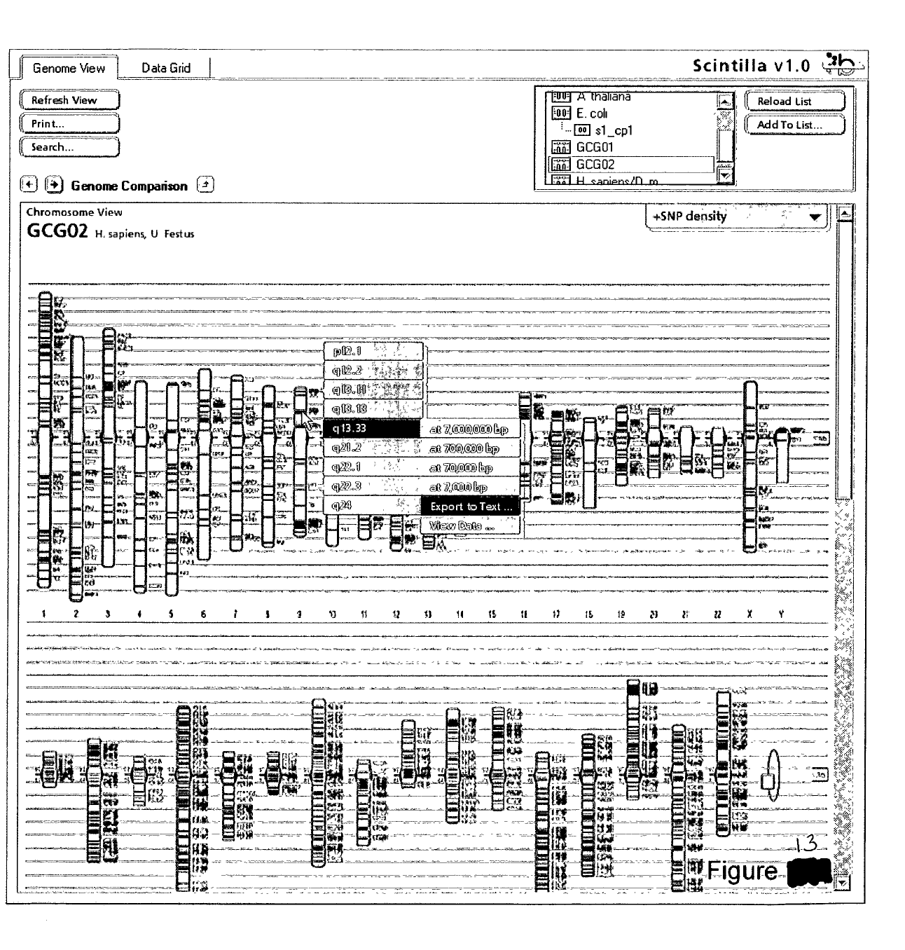

Another function of the graphical interface is the Genome Comparison Graph. This also operates in a multi-entry fashion, with one view being that of the ideograms of the desired genomes. FIG. 13 is an illustration of the top most full-genome view of two genomes, where different chromosome types, i.e., linear vs. circular and with centromere vs. without centromere, are presented in distinct graphic representations. The ideogram illustrates the genes (or other markers) which have homology in other genome(s). Once a marker is selected, homologous markers on the other genome(s) become visible. A selected band shows homology data in report format. The relative positions of larger objects such as individual genomes or tracks can be rearranged according to user preference, in either the tree view, whole genome view, or the track views. The graphical interface can provide side-by-side views of multiple genomes with homology information summarized. Detailed information on individual groups of homologs is interactively provided by navigating through the genomes or by direct search for individual objects by name, keywords, and/or sequence.

The genomic data can be tied together through Client-Server, and/or Application Service Provider (ASP) based technology. Vector graphics, as provided by software products, such as Flash by Macromedia, Inc., are used to represent genomic data as biological objects. Vector graphic technology is used to represent multiple levels of genomic data associated with the biological objects. The use of vector-based graphics to render data into objects allows data, such as chromosomes, genes, markers, and unit intervals, the capability of being responsive and interactive. This in turn allows a high volume of information to be conveyed by a consistent, yet dynamic interface. The data is accessed by associating multiple attributes (such as shape, color, gradients, texture, position, label, mouse-over, URL link) with each vector graphic object. The source data format, whether it is relational database, xml, flat files, DAS or other is transformed into Vector graphic objects. It should be noted that data visualization is not limited to vector graphic; any object-based methods that provide responsive and interactive component functionalities, such as dynamic HTML, can be used. Any particular view constitutes only one instance of the multiple representations possible.

Data can be obtained from public data sources (e.g. Ensembl, Golden Path, NIH, OMIM) including, but not limited to, any available public bioinformatic data sources or from private data sources, such as, for example, a user's own bioinformatic data. Data can be mapped from one source onto another source in order to visualize levels of data complexity, e.g., various markers are re-mapped to their genomic positions according to current sequencing map information.

The graphical interface permits transitive mapping. Transitive mapping allows for the preservation and accumulation of select information across multiple mappings of two or more different data sources, each source filling in additional information missing in the previous source(s). Further, the graphical interface permits extensible mapping. Extensible mapping allows a user to map their genomic data onto third party genomic data structures for the visualization of user genomic data in relation to standards acceptable by third parties.

Objects can be searched by object name, keyword, sequence, etc. Results can be returned either as a graphic view, or in summary reports.

The graphical interface can provide Basic Local Alignment Search Tool (BLAST) functionality for base pair sequences selected by the user, using the genome sequence as the target sequence in a BLAST or BLAST like run. This is done in the search page, using the graphical interface to select an object's sequence as the query sequence in a BLAST run and limit BLAST search results by their relationship with landmarks (objects) on the sequence backbone. BLAST searches are enabled through the user interface using ASP technology.

The graphical interface can also provide on-screen sequence manipulation tools, such as primer design, restrictive enzyme mapping, mutagenesis design, and amino acid sequence translation, to facilitate experiment designs by a user.

Recently visited objects can be cached for improved performance. For example, objects can be cached on the server-side to improve system performance

The vector graphic objects painted on the screen are responsive and interactive. Mouse maneuvers such as mouse-over or clicking on an object triggers the server-side display of either an instant report, or a new view, again represented by vector graphics, or other, graphics. The trigger requests representations of data stored in memory or retrieval from a database (via database queries or stored procedures).

User notes are entered via input boxes in the graphical interface, with configuration options so that the data can be associated with either an object or a position associated with specified coordinates in a specific view. These are stored as vector graphic objects in a separate table within a database or optionally, within an external proprietary catalog. Annotations are accessed in the user interface through the Vector graphic objects.

The graphical interface can be used with genomic data obtained from various organisms spanning the evolutionary spectrum that has been integrated into a relational database. The genomic data (e.g. biological sequences, annotation objects, user notes, statistical data, gene expression data, homology and other types of comparison data, statistical analysis, gene discovery, marker mapping, gene expression analysis, and is not limited to biological data, but can be any types of biological data and can be used as is or can be modified, analyzed, summarized, and/or derived and/or otherwise processed) can be stored in a relational database, wherein the data is put in a universal format to allow comparison of the disparate genomic data. Data inconsistency often exists among data originated and/or obtained from different sources. Inconsistent data are noted and/or conformed to a consistent state. These inconsistencies are identified manually in the database and/or visually through the graphical interface and resolved on the database end.

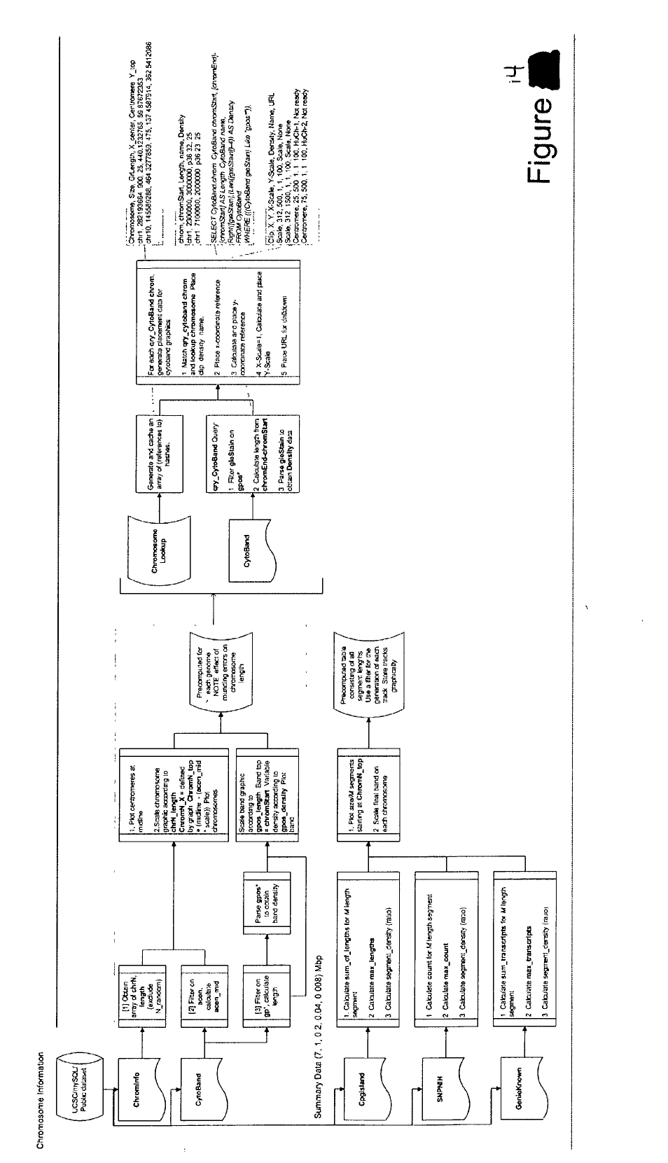

The graphical interface can be used with bioinformatic data from divergent sources. FIG. 14 is an illustration of a data processing flow that combines data into a single data format. For example, each cytoband object is associated with a specific chromosome, at a specific location and is of a specific size. Density of cytoband is calculated and scaled for the chromosome. Cytoband data are precomputed for each genome and a URL is assigned to the coordinates of each object. When a user queries a cytoband, data are returned via the URL. Biological data can be provided either by importing into a Relational Database Management System (RDMS), other database, or via TCP/IP or other network link to the data provider. Databases can be maintained locally or remotely. In the later case, an ASP model can be used. Data can be retrieved using the graphical interface from a local database, a remote database, and/or web resources using real-time network access. Report data can then be integrated from both local and remote data sources and displayed using the graphical interface. Database searches can also be performed using direct queries to a single database or multiple databases.

Annotations may be associated with any type of landmarks, e.g., marker object, genome location, etc through the graphical interface. Annotation data can be stored either in a local or remote database, or other networked database. Annotation data located in either the local or a remote database will be visualized in the user interface. Remote databases can be accessed via an application-programming interface (e.g. Open Database Connectivity, ODBC) or via import through a parser. Annotations can be incorporated into any given track through the addition of data to a database through the graphical interface. Further, data can be exported to the client-side computer, either as a flat file or in a database.

A user can store user data in a local or remote database, allowing integration of user data with data available from other public domain or private data sources. The user has full access to their data, and has the option to make these data private or open to the public. According to at least one embodiment, an RDMS database, with management utilities built-in is used. In addition, users may access a database across a corporate network, or through the world-wide-web at a hosted location (ASP model). The database can be an architecture comprising combinations of commercial and/or public relational and flat-file databases.

The graphical interface permits users to add custom modules for conducting analyses. Modules with specialized functionality are connected to the graphical interface as necessary through ASP queries.

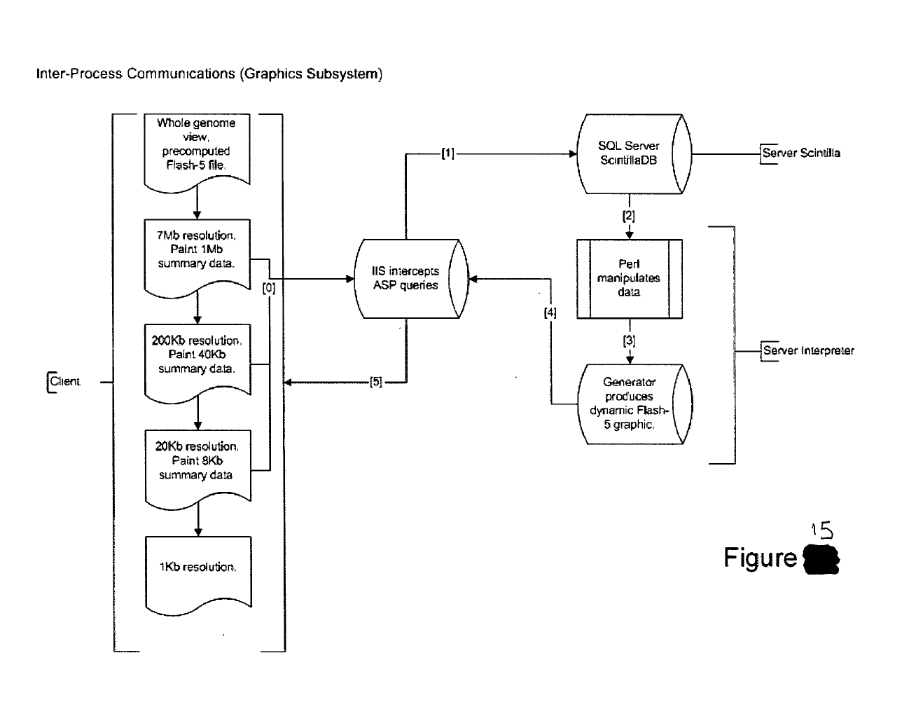

For each graphic view, data are obtained through database queries or RDMS stored procedures, issued by component programs (e.g., perl scripts, C++ executables, etc). The query results are again parsed by these component programs and fed to a vector graphic generator (e.g. Flash, Macromedia, Inc), which in turn paints the data as various vector graphic objects on the screen. FIG. 15 is an illustration of the inter-process communications. For example, when a user selects a genome from the menu, the query is passed through the Internet Information Server (IIS) and sent to the database on the server computer. The interpreter component of the server manipulates the data and feeds it to the vector graphics generator. The generator sends the graphic objects back through the IIS to display the objects on the user's computer.

Additional tracks of biological data or custom tracks are populated with a user's data. These data are either imported to the database from a RDMS or flat file or they are pulled from a remote database or flat file in real time. In either case, the data are dynamically converted into data objects and are rendered as graphical objects in the graphical interface. Custom data tracks can be imported directly to a database, as data from public sources, but with the optional public access restrictions.

The graphical interface can be integrated with statistical analysis tools and/or software to provide statistical analysis of biological data and present summary reports visually. For example, a statistical algorithm can be integrated into the graphical interface capable of filtering genomic data (e.g. chromosome regions associated with a disease) based on a set criteria in order to visualize only the most statistically significant data (e.g. only regions which are statistically significantly associated with the disease are highlighted graphically).

In general, the various components of embodiments of the present invention can be implemented in hardware, software, or a combination thereof. In such embodiments, the various components and steps would be implemented in hardware and/or software to perform the functions of the present invention. Any presently available or future developed computer software language and/or hardware components can be employed in such embodiments of the present invention. For example, at least some of the functionality mentioned above could be implemented using C, C++, JAVA, Perl, or ASP scripting programming languages or combinations thereof. The graphical interface can be implemented using software stored on a disk, in memory, or other computer-readable medium.

Although the invention has been described and illustrated in the foregoing exemplary embodiments, it is understood that the present disclosure has been made only by way of example, and that numerous changes in the details of construction and combination and arrangement of processes and equipment may be made without departing from the spirit and scope of the invention.

The above embodiments can be implemented with one or multiple data integration modules designed to accommodate diverse data sources. These modules could serve as data warehouses for bioinformatics data. The embodiments also can be implemented using multiple visualization modules designed to illustrate aspects of the genomic data. Annotation components can be used to store data associated with database objects. These components can be distributed throughout a local or wide area network. The embodiments can use combinations of numerous commercial and/or public relational and flat-file databases, and can use previously computed bioinformatics analyses (e.g. Gene expression analyses from a recent publication). A high-throughput analysis pipeline can be used to automate and store custom analyses.

Therefore, the foregoing should be considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A method of displaying biological data comprising:
providing at least one database comprising biological data, wherein said biological data includes genomic data;
receiving at least one query; and
displaying a first type of biological data and a second type of biological data, wherein said first type of biological data is displayed as a first graphic object at a first scale and said second type of biological data is displayed as a second graphic object at said first scale, wherein each of said first graphic object and said second graphic object comprises a plurality of links to biological data at a second scale, wherein said second scale is different than said first scale.

2. The method according to claim 1, wherein said first graphic object and said second graphic object are vector graphic objects.

3. The method according to claim 1, wherein said second type of biological data is overlaid said first type of biological data.

4. The method according to claim 1, wherein said at least one query comprises a request to display a predefined number of base pairs.

5. The method according to claim 1, wherein said at least one query comprises a string of base pairs.

6. The method according to claim 1, wherein said first scale comprises biological data not displayed in said second scale.

7. The method according to claim 1, wherein each type of biological data is displayed as a track, wherein each of said track is adjacent to another track.

8. The method according to claim 7, wherein each of said track is adjustably ordered relative to other tracks.

9. The method according to claim 1, wherein said first type of biological data comprises at least one of gene boundaries, chromosome bands seen on Giemsa-stained chromosomes, FISH mapped clones, Sequence Tagged Sites, orthologous (syntenic) regions between mouse and human chromosomes, percentage of bases that are G or C within a predefined base window, contigs of clones, gaps in the assembly, coverage level of the genome, gene predictions from Project Ensembl, CpG islands, Expressed Sequence Tags, UniGene data, Single Nucleotide Polymorphisms, Simple Tandem Repeats, linkage markers, GenScan data, predicted exons, known genes, homologues, and custom annotations.

10. The method according to claim 9, wherein said second type of biological data comprises at least one of gene boundaries, chromosome bands seen on Giemsa-stained chromosomes, FISH mapped clones, Sequence Tagged Sites, orthologous (syntenic) regions between mouse and human chromosomes, percentage of bases that are G or C within a predefined base window, contigs of clones, gaps in the assembly, coverage level of the genome, gene predictions from Project Ensembl, CpG islands, Expressed Sequence Tags, UniGene data, Single Nucleotide Polymorphisms, Simple Tandem Repeats, linkage markers, GenScan data, predicted exons, known genes, homologues, and custom annotations.

11. The method according to claim 1, wherein said at least one database is a relational database.

12. The method according to claim 1 wherein said first type of biological data and said second type of biological data are displayed as a cartoon.

13. The method according to claim 1 wherein said first scale is at a chromosome level of information and said second scale is at a base pair level of information.

14. The method according to claim 1 wherein said biological data includes textual information associated with a predefined base pair sequence.

15. The method according to claim 1, wherein said first scale is a macroscopic biological data set and said second scale is a subset of said macroscopic biological data set.

16. The method according to claim 1, wherein said first scale is a subset of said biological data from a macroscopic biological data set and said second scale is said macroscopic biological data set.

17. The method according to claim 1, wherein said first type of biological data is obtained from a first experimental technique and said second type of biological data is obtained from a second experimental technique.

18. The method according to claim 17, wherein said first experimental technique is Geimsa staining.

19. The method according to claim 17, wherein the biological data obtained from said first experimental technique and said second experimental technique is displayed as a cartoon.

20. The method according to claim 1, further comprising removing predefined biological data from at least one of said first type of biological data or second type of biological data, wherein said step of removing predefined biological data reveals biological regions associated with at least one of a disease, a gene function, or a gene.

21. A method for displaying biological data from a first organism and a second organism, said method comprising:
providing at least one database comprising biological data, wherein said biological data includes genomic data;
receiving at least one query; and
displaying biological data obtained from a first organism and biological data obtained from a second organism, wherein said biological data obtained from a first organism is displayed as a first graphic object at a first scale and said biological data obtained from a second organism is displayed as a second graphic object at said first scale, wherein each of said first graphic object and said second graphic object comprises a plurality of links to biological data at a second scale, wherein said second scale is different than said first scale.

22. A computer system comprising:
a database including biological data, wherein biological data includes genomic data; and
a user interface capable of displaying a first type of biological data and a second type of biological data, wherein said first type of biological data is displayed as a first graphic object at a first scale and said second type of biological data is displayed as a second graphic object at said first scale, wherein each of said first graphic object and said second graphic object comprises a plurality of links to biological data at a second scale, wherein said second scale is different than said first scale.

23. A computer program product comprising a computer-readable medium having computer-readable program code embodied thereon relating to a database including biological data, the computer product comprising computer readable program code for effecting the following steps within a computer system:
receiving at least one query; and
displaying a first type of biological data and a second type of biological data, wherein said first type of biological data is displayed as a first graphic object at a first scale and said second type of biological data is displayed as a second graphic object at said first scale, wherein each of said first graphic object and said second graphic object comprises a plurality of links to biological data at a second scale, wherein said second scale is different than said first scale.

24. A method of displaying biological data comprising:
a means for providing at least one database comprising biological data, wherein said biological data includes genomic data;
a means for receiving at least one query; and
a means for displaying a first type of biological data and a second type of biological data, wherein said first type of biological data is displayed as a first graphic object at a first scale and said second type of biological data is displayed as a second graphic object at said first scale, wherein each of said first graphic object and said second graphic object comprises a plurality of links to biological data at a second scale, wherein said second scale is different than said first scale.
